(19) United States
(12) Patent Application Publication
(10) Pub. No.: US 2006/0067754 A1
(43) Pub. Date: Mar. 30, 2006

(54) Fuser assembly with six layer endless belt in an electrophotographic imaging device

(76) Inventors: James D. Gilmore, Lexington, KY (US); Gillian J. Ross, Lexington, KY (US); Jerry W. Smith, Irvine, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/955,537

(22) Filed: Sep. 29, 2004

(51) Int. Cl. G03G 15/20

(52) U.S. Cl. 399/333

(57) ABSTRACT

An electrophotographic imaging device includes a print media transport assembly and a fuser positioned in association with the print media transport assembly. The fuser includes a heater assembly having a ceramic substrate and an endless flexible belt positioned around the heater assembly. The flexible belt includes an inner base layer comprised of a polyimide with a thermally conductive filler; a metallic layer adjacent the base layer; a first primer layer adjacent the metallic layer; a thermally conductive elastic coating adjacent the first primer layer; a second primer layer adjacent the thermally conductive elastic coating; and an outer release layer adjacent the second primer layer.

### BACKGROUND OF THE INVENTION

1. Field of the Invention

The present invention relates generally to electrophotographic imaging devices and, more particularly, to fusers of electrophotographic imaging devices.

2. Description of the Related Art

In the electrophotographic (EP) imaging process used in printers, copiers and the like, a photosensitive member, such as a photoconductive drum or belt, is uniformly charged over an outer surface. An electrostatic latent image is formed by selectively exposing the uniformly charged surface of the photosensitive member. Toner particles are applied to the electrostatic latent image, and thereafter the toner image is transferred to the media intended to receive the final permanent image. The toner image is fixed to the media by the application of heat and pressure in a fuser. A fuser may include a heated roll and a backup roll forming a fuser nip through which the media passes. A fuser may also include a fuser belt and an opposing backup member, such as a backup roll.

In color EP imaging, time to first print from cold start is an important factor. If the time to first print is short enough, the printer need not use standby mode, and therefore significantly reduces power usage. The environmental impact of reducing power usage has led to the “Energy Star Program” developed by the “Sustainable Energy Development Authority” (SEDA). SEDA is a New South Wales government agency that runs in conjunction with the USA Environmental Protection Agency (EPA). These governmental agencies promote the reduction in power usage by setting the Energy Star rating for low power.

Traditional two soft roller fusing systems have a long warm up time, as a result of the high thermal mass inherent in the elastomer covered metal rolls. Power usage in standby modes for typical color machines using a roller system is 150 to 200 watts, which meets the current Energy Star certification. There is discussion to change the Energy Star certification requirement to 45 watts maximum usage when not printing, which would prevent fixing roller fusers from obtaining Energy Star certification. Belt fuser systems typically have a much lower thermal mass and therefore a significantly reduced warm up time so that standby mode is not required. Print quality of transparencies, and gloss variation in paper printing, is still a problem in color belt fusing systems. These problems result from a lack of conformity to the changing toner pile heights experienced in color fusing.

What is needed in the art is a fuser which allows for the use of a polyimide base layer belt for color printing, provides improved gloss and transparency quality for high speed printing with a ceramic heater, and provides improved print media release properties with less print artifacts.

### SUMMARY OF THE INVENTION

The present invention provides a fuser with a six layer endless flexible belt resulting in improved gloss in paper printing and improved transmittance in transparency printing.

The invention comprises, in one form thereof, an electrophotographic imaging device, including a print media transport assembly and a fuser positioned in association with the print media transport assembly. The fuser includes a heater assembly having a ceramic substrate and an endless flexible belt positioned around the heater assembly. The flexible belt includes an inner base layer comprised of a polyimide with a thermally conductive filler; a metallic layer adjacent the base layer; a first primer layer adjacent the metallic layer; a thermally conductive elastic coating adjacent the first primer layer; a second primer layer adjacent the thermally conductive elastic coating; and an outer release layer adjacent the second primer layer.

The endless flexible belt design for the fuser is large in diameter, has a thin resin base, a thin metal layer, a thick elastic layer, and a release layer. The thin base layers in conjunction with the thick elastic layer allows the belt to conform to the difference in toner pile heights experienced in color fusing. The large belt size allows a large nip for high residence time, and the filler that is added to the base resin layer increases the thermal conductivity of the layer, improving heat conduction. The increased heat conductivity of the base resin and metal layer combination provides a belt fuser system capable of running at higher speeds than traditional thick polyimide belts.

In a color system employing the fuser belt of the present invention, speeds of 28 ppm and higher can be achieved with excellent print quality; and therefore, this fuser belt design can be considered for use in higher end machines. To keep the fuser low in cost, a ceramic heating system is used as opposed to a high cost induction heating system. A rubber pad underneath the fusing belt on the exit of the nip area is also used to increase the exit pressure to improve print quality.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic view of an imaging device, in the form of a printer, incorporating a fuser of the present invention;

FIG. 2 is an exploded, perspective view of an embodiment of a portion of a fuser of the present invention;

FIG. 3 is an assembled, end view of the portion of the fuser shown in FIG. 2; and

FIG. 4 is a sectional, end view of the endless belt shown in FIGS. 2 and 3.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

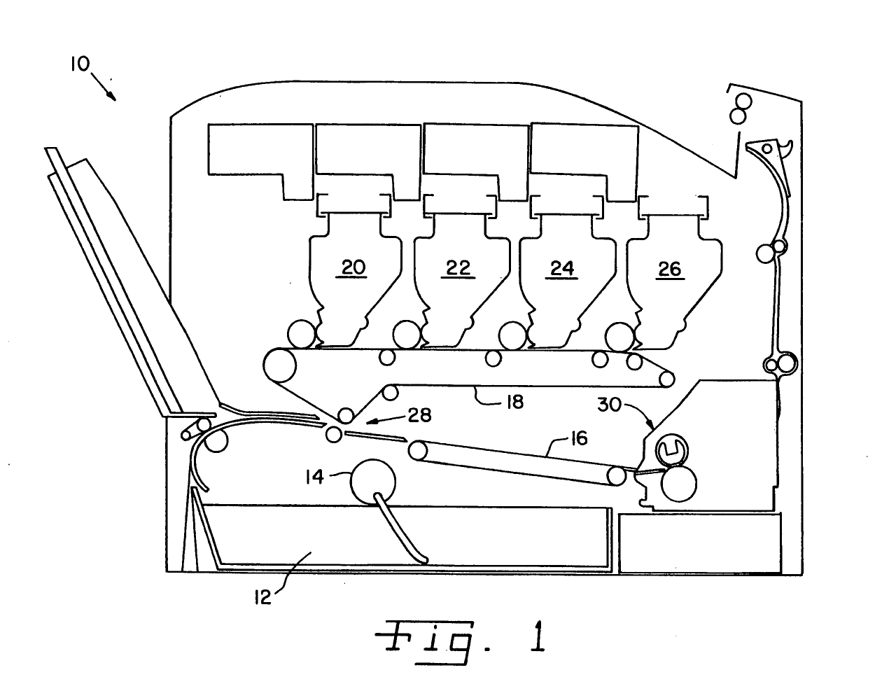

Referring now to the drawings and particularly to FIG. 1, there is shown an embodiment of an EP printer 10 of the present invention. Paper supply tray 12 contains a plurality of print media (not shown), such as paper, transparencies or the like. A print medium transport assembly (not numbered) includes a plurality of rolls and/or transport belts for transporting individual print media through EP printer 10. For example, in the embodiment shown, the print medium transport assembly includes a pick roll 14 and a paper transport belt 16. Pick roll 14 picks an individual print medium from within paper supply tray 12, and the print medium is transported past an intermediate transfer member (ITM) in the form of an ITM belt 18. A plurality of color imaging stations 20, 22, 24 and 26 apply toner particles of a given color to ITM belt 18 at selected pixel locations. The toner particles are then transferred from ITM belt 18 to the print medium in nip 28. In the embodiment shown, color imaging station 20 is a black (K) color imaging station; color imaging station 22 is a magenta (M) color imaging station; color imaging station 24 is a cyan (C) color imaging station; and color imaging station 26 is a yellow (Y) color imaging station.

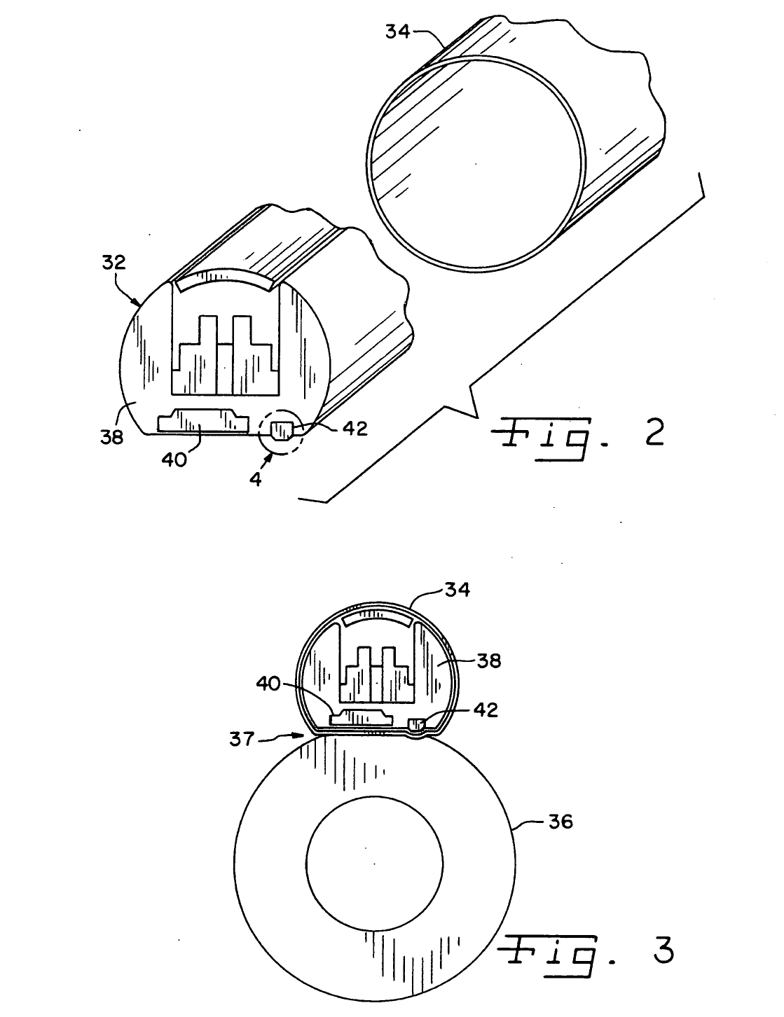

Paper transport belt 16 transports an individual print medium to fuser 30 (FIGS. 1-3) where the toner particles are fused to the print medium through the application of heat and pressure. Fuser 30 includes a heater assembly 32, flexible belt 34 carried by heater assembly 32, and backup member in the form of a backup roll 36. In the embodiment shown, backup roll 36 is a driven roll and flexible belt 34 is an idler belt; however, the drive scheme may be reversed depending upon the application. Belt 34 and backup roll 36 define a fuser nip 37 therebetween.

Backup roll 36 has a metallic core and an elastomeric covering, but may be differently configured. Techniques for the general concept of rotatably driving backup roll 36 using gears, belts, pulleys and the like (not shown) are conventional and not described in detail herein.

Heater assembly 32 includes a high temperature housing 38 (liquid crystal polymer or the like) carrying a ceramic heater 40. Ceramic heater 40 includes a ceramic substrate (alumina, aluminum nitride, etc.), a resistive ink pattern screened onto the substrate, and one or more glass protective layers. Other types of ceramic heaters may also be used. Housing 38 includes a small slot cut in a longitudinal direction at the nip exit side of the housing. A resilient pad 42 of a defined thickness and hardness is placed within this longitudinal slot.

The shape of resilient pad 42, preferably formed from an elastomeric material, has been shown to affect release characteristics. Rather than a standard rectangle cross-section, it has been found that a trapezoidal shape is preferred. This shape shows an improvement in release and reduction in curl when compared to a similar rectangle shaped pad.

The height differential between elastomeric pad 42 and the heater surface (unloaded), should be in the range of 0.5 to 3 mm. A height differential in the range of between 0.5 to 3 mm has been found to be effective, with a smaller height differential resulting in no effect being seen, and a greater height differential resulting in the paper being bent at an angle such that +W curl is imparted to the print media.

The needed height difference may change depending on the location of the pad within the fusing nip and size of the backup roller. Moving the pad towards the entry side reduces the needed height, whereas moving it towards the exit requires a more extreme height difference. The radius of the backup roller plays a roll in that a smaller roll has a tighter radius and thus a larger height pad may be needed to generate enough contact between the backup roller and pad to create the needed pressure differential.

The hardness of the elastomer used in resilient pad 42 is proportional to transmittance and curl; that is the harder the elastomer the greater gains seen in transmittance and the worse the paper curl imparted. In one embodiment, resilient pad 42 has a hardness ranging from 10 to 50 Shore A. Testing has shown that a hardness over 50 Shore A results in unacceptable levels of curl and a hardness under 10 Shore A results in no significant improvement in gloss or transmittance.

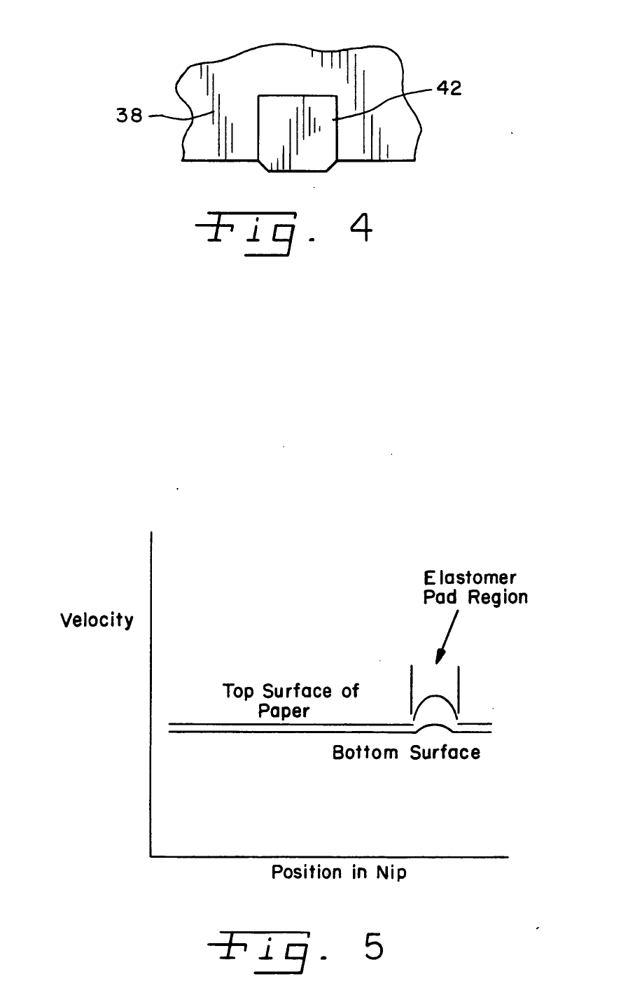

Referring now to FIG. 4, belt 34 will be described in greater detail. Belt 34 includes an inner base layer 50 which is a thermally conductive Upilex-S polyimide. The high thermal conductivity of the Upilex-S polyimide is achieved by the addition of boron nitride at a rate of 10 to 50% by weight. Base layer 50 is a thin layer with a thickness of between 5 to 50 microns. Base layer 50 prevents wear of ceramic heater 40 and provides electrical insulation properties and flexibility to belt 34. Belt 34 needs to be stiff enough to prevent buckling yet flexible enough to conform in the nip to the change in the toner pile heights.

Metallic layer 52 is radially adjacent to base layer 50. In the embodiment shown, base layer 50 is formed on the inside of a drawn stainless steel tube 52 by a specially designed spin coating method followed by imidization.

Another belt type considered consists of a thicker Upilex-S polyimide belt which could be made by dispensing the polyamic acid, made from BPDA (bisphenyl dianhydride) and PDA (phenylene diamine), on a spinning mandrel and imidizing. This is a method used for making polyimide belts for mono printers. This belt of approximately 20 to 70 microns in thickness could then be coated with a metallic layer of approximately 10 to 70 microns again providing a thermally conductive, yet flexible belt.

Fuser belts of known design may have a metallic layer with electroformed nickel which is known to have cracking issues at temperatures near or above 200° C. On the other hand, metallic layer 52 does not use nickel but rather stainless steel or copper. These metals do not have the cracking issues observed in nickel belts and therefore 100% imidization is carried out. By fully imidizing the polyamic acid, a coating with higher modulus is obtained. A primer layer 54 is then applied to metallic layer 52 for sufficient adhesion of the next layer to be applied. Primer layer 54 is between 1 to 5 microns in thickness and is applied, e.g., by spray coating or dip coating. A primer such as Shin-Etsu primer X-33-156-20 is suitable for this metallic to elastic adhesion.

An elastomer layer 56 having a thickness of between 150 to 600 microns is spray coated on the surface of primer 54. Elastomer 56 is preferably a silicone rubber with a thermal conductivity of between 0.6 to 2.0 W/m° k, preferably between 0.8 to 1.2 W/m° k. Elastomer 56 has a durometer of less than 60 shore A, preferably between 5 to 35 shore A. Shin-Etsu manufactures at least three different silicone rubbers that are suitable for this layer, X-34-2451, X-34-2452 and X-34-2453. Elastomer layer 56 is thick enough and soft enough to conform to the changing pile heights of the color toner, yet thermally conductive enough to be used in a high speed, low thermal mass fuser. Elastomer layer 56 is heated prior to the application of the next primer layer 58.

Primer layer 58 is applied by spray coating or dip coating, again 1 to 5 microns thick. This is for the adhesion of elastomer layer 56 to a release layer 60. Release layer 60 can either be a fluororesin sleeve or a fluororesin coating of 5 to 100 microns in thickness, preferably between 10 to 30 microns in thickness. Spray coating or dip coating is suitable for application of the fluororesin coating. Release layer 60 is coalesced in conjunction with the final curing step of primer layer 58.

A fluororesin sleeve (not shown) may be applied over elastomer layer 56 prior to curing, and elastomer layer 56 is then cured while in contact with the sleeve.

In fuser 30, belt 34 slides over high temperature heater housing 38 containing ceramic heater 40 and resilient pad 42. Ceramic heater 40 is located on the inside of belt 34, opposite backup roll 36 located on the outside of belt 34. Backup roll 36 is pushed against belt 34 in fusing nip 37 encompassing the width of ceramic heater 40 and resilient pad 42. Ceramic heater 40 is therefore under high pressures that has lead to heater cracking with conventional designs.

The careful design of belt 34 as well as the use of resilient pad 42 on the exit side of fuser nip 37 allows a suitable pressure to achieve high gloss. The design of a stronger ceramic heater has enabled the system to run at a higher pressure without the risk of breaking ceramic heater 40. Ceramic heater 40 consists of a ceramic substrate, a resistive ink pattern on the substrate followed by one or more glass protective layers. The substrate is an alumina ceramic, which has two opposed concave regions that are laminated together. The two layers sintered together under pressure and heat with no adhesive layer, form a flat ceramic substrate. Thick film printing is then used to apply the electrical resistive elements for heating on the surface of the substrate.

Careful selection of the durometer, shape, height, and thickness of resilient pad 42 on the exit side of fuser nip 37 provides a pressure profile that is suitable for high gloss images and transparencies with high transmittance. The relatively large nip is provided by the wide heater trace and the large diameter of belt 34 (at least 24 mm diameter). The relatively large diameter backup roll 36 also provides a high residence time which further improves the gloss on images and transmittance on transparencies.

Current color belt fusing systems use expensive belts and heating methods, yet still suffer from significant print quality issues. Although time to first print has been reduced dramatically providing quick heating fusing systems, high gloss images cannot be achieved, and significant gloss variation is observed. Also the transmittance on transparencies is poor and could be considered unacceptable. High speeds over 28ppm have not been achieved in ceramic heated color belt fusing systems. The use of belt 34 described above provides an instant-on belt fusing system that achieves high speeds, and high print quality such as uniform high gloss and high transmittance on transparencies, with a low-cost heating system.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electrophotographic imaging device, comprising:
a print media transport assembly; and
a fuser positioned in association with said print media transport assembly, said fuser including:
a heater assembly having a ceramic substrate; and
an endless flexible belt positioned around said heater assembly, said flexible belt including:
an inner base layer comprised of a polyimide with a thermally conductive filler;
a metallic layer adjacent said base layer;
a first primer layer adjacent said metallic layer;
a thermally conductive elastic coating adjacent said first primer layer;
a second primer layer adjacent said thermally conductive elastic coating; and
an outer release layer adjacent said second primer layer.

2. The electrophotographic imaging device of claim 1, wherein said flexible belt has an inner diameter in an unloaded state of at least approximately 24 mm.

3. The electrophotographic imaging device of claim 1, wherein said inner base layer has a thickness of between approximately 5 to 70 microns.

4. The electrophotographic imaging device of claim 1, wherein said inner base layer polyimide is comprised of Upilex S and said thermally conductive filler is comprised of boron nitride at a rate of between approximately 10 to 50% by weight.

5. The electrophotographic imaging device of claim 1, wherein said metallic layer is comprised of one of stainless steel and copper.

6. The electrophotographic imaging device of claim 1, wherein said metallic layer has a thickness of between approximately 10 to 70 microns.

7. The electrophotographic imaging device of claim 1, wherein said thermally conductive elastic coating has a thickness of between approximately 150 to 600 microns.

8. The electrophotographic imaging device of claim 1, wherein said thermally conductive elastic coating is comprised of silicone rubber.

9. The electrophotographic imaging device of claim 8, wherein said silicone rubber has a durometer of less than approximately 60 Shore A.

10. The electrophotographic imaging device of claim 9, wherein said silicone rubber has a durometer of between approximately 5 to 35 Shore A.

11. The electrophotographic imaging device of claim 8, wherein said silicone rubber has a thermal conductivity of between approximately 0.6 to 2.0 W/mk.

12. The electrophotographic imaging device of claim 11, wherein said silicone rubber has a thermal conductivity of between approximately 0.8 to 1.2 W/mk.

13. The electrophotographic imaging device of claim 1, wherein said outer release layer is comprised of a fluorocarbon resin.

14. The electrophotographic imaging device of claim 13, wherein said outer release layer has a thickness of between approximately 5 to 100 microns.

15. The electrophotographic imaging device of claim 14, wherein said outer release layer has a thickness of between approximately 10 to 30 microns.

16. The electrophotographic imaging device of claim 1, wherein said fuser includes a backup member positioned in opposition to said heater assembly on a side of said flexible belt opposite said heater assembly, said flexible belt and said backup member defining a fusing nip therebetween.

17. The electrophotographic imaging device of claim 1, wherein said heater assembly includes a housing carrying said heater and a resilient pad, said resilient pad extending from said housing and positioned at an exit side of said housing relative to a direction of travel of said flexible belt.

18. The electrophotographic imaging device of claim 17, wherein said resilient pad comprises an elastomeric pad.

19. The electrophotographic imaging device of claim 18, wherein said elastomeric pad has a hardness of between 10 to 50 Shore A.

20. The electrophotographic imaging device of claim 18, wherein said heater has an outer surface, and said elastomeric pad extends from said outer surface a distance of between 0.5 to 3 mm in an unloaded state.

21. A fuser for an electrophotographic imaging device, said fuser comprising:
a heater assembly having a ceramic substrate; and
an endless flexible belt positioned around said heater assembly, said flexible belt including:
an inner base layer comprised of a polyimide with a thermally conductive filler;
a metallic layer adjacent said base layer;
a first primer layer adjacent said metallic layer;
a thermally conductive elastic coating adjacent said first primer layer;
a second primer layer adjacent said thermally conductive elastic coating; and
an outer release layer adjacent said second primer layer.

22. The fuser of claim 21, wherein said inner base layer has a thickness of between approximately 5 to 70 microns.

23. The fuser of claim 21, wherein said inner base layer polyimide is comprised of Upilex S and said thermally conductive filler is comprised of boron nitride at a rate of between approximately 10 to 50% by weight.

24. The fuser of claim 21, wherein said metallic layer is comprised of one of stainless steel and copper.

25. The fuser of claim 21, wherein said metallic layer has a thickness of between approximately 10 to 70 microns.

26. The fuser of claim 21, wherein said thermally conductive elastic coating has a thickness of between approximately 150 to 600 microns.

27. The fuser of claim 21, wherein said thermally conductive elastic coating is comprised of silicone rubber.

28. The fuser of claim 27, wherein said silicone rubber has a durometer of less than approximately 60 Shore A.

29. The fuser of claim 28, wherein said silicone rubber has a durometer of between approximately 5 to 35 Shore A.

30. The fuser of claim 27, wherein said silicone rubber has a thermal conductivity of between approximately 0.6 to 2.0 W/mk.

31. The fuser of claim 30, wherein said silicone rubber has a thermal conductivity of between approximately 0.8 to 1.2 W/mk.

32. The fuser of claim 21, wherein said outer release layer is comprised of a fluorocarbon resin.

33. The fuser of claim 21, wherein said outer release layer has a thickness of between approximately 5 to 100 microns.

34. The fuser of claim 33, wherein said outer release layer has a thickness of between approximately 10 to 30 microns.

35. An endless flexible belt for use in a fuser in an electrophotographic imaging device, said flexible belt having an inner diameter in an unloaded state of at least approximately 24 mm, said flexible belt comprising:
an inner base layer comprised of a polyimide with a thermally conductive filler;
a metallic layer adjacent said base layer;
a first primer layer adjacent said metallic layer;
a thermally conductive elastic coating adjacent said first primer layer;
a second primer layer adjacent said thermally conductive elastic coating; and
an outer release layer adjacent said second primer layer.
